(19) United States
(12) Patent Application Publication
(10) Pub. No.: US 2025/0021617 A1
(43) Pub. Date: Jan. 16, 2025

(54) METHOD AND SYSTEM FOR ANALYZING PRECIPITATION NORMALIZATION BY GRADIENT-BASED PARAMETER OPTIMIZATION

(71) Applicant: SUN YAT-SEN UNIVERSITY, Guangdong (CN)

(72) Inventors: Tongtiegang ZHAO, Guangdong (CN); Zeqing HUANG, Guangdong (CN); Xiaohong CHEN, Guangdong (CN)

(73) Assignee: SUN YAT-SEN UNIVERSITY, Guangdong (CN)

(21) Appl. No.: 18/280,945

(22) PCT Filed: Aug. 17, 2022
(86) PCT No.: PCT/CN2022/113078

§ 371 Date: Sep. 8, 2023

(51) Int. Cl. G06F 17/14; G01W 1/10

(52) U.S. Cl. CPC G06F 17/147; G01W 1/10

(57) ABSTRACT

The present invention provides a method and system for analyzing precipitation normalization by gradient-based parameter optimization. The method includes the following steps: acquiring precipitation data to be analyzed; constructing a normal transformation model to perform normal transformation on the precipitation data, to obtain a normal variable Z; letting the normal variable Z to obey normal distribution to construct a joint probability density function of the normal variable Z; constructing a likelihood function for parameter optimization based on the normal transformation model and the joint probability density function; deducing an analytic gradient vector of the likelihood function to optimize the likelihood function till a predetermined termination condition is satisfied, to obtain the optimum parameter enabling the maximum value of the likelihood function; and updating the normal transformation model based on the optimum parameter, and performing normal transformation and modeling analysis on the precipitation data to obtain a precipitation normalization analysis result.

### BACKGROUND

### Technical Field

The present invention relates to the technical field of hydrologic data processing, and particularly relates to a method and system for analyzing precipitation normalization gradient-based parameter optimization.

### Description of Related Art

Precipitation data is important hydrometeorological observation data, and conducting modeling analysis for precipitation data is an effective way to develop precipitation data products, analyze drought events in a drainage basin and conduct hydrologic forecasting. Affected with natural attributes of precipitation, the precipitation data usually shows non-normal distribution. On the one hand, precipitation usually shows positive skewed distribution, featuring high skewness and kurtosis. On the other hand, precipitation has a natural lower boundary, i. e., the minimum value of precipitation is zero, resulting in discrete-continuous mixed distribution of the precipitation data. However, many statistical analysis methods conduct deduction based on the premise of normal distribution presently, and thus, non-normal features of the precipitation data will induce a more complicated modeling analysis process thereof and have certain impact on the statistical analysis result.

Oriented to the non-normal features of precipitation, at present, common methods are normal transformation methods such as Log transformation. Box-Cox transformation and Log-sinh transformation which convert the non-normal precipitation data into data obeying normal distribution and further perform modeling analysis. Different transformation methods have different transformation parameters, and the parameters have different impacts on normal transformation methods. The common methods set the transformation parameters as a matter of experience. However, empirical parameter setting is difficult to adapt to precipitation distribution features under different climatic conditions. Therefore, the accuracy of the analysis result of the precipitation data obtained therefrom is to be improved.

### SUMMARY

To overcome the defect that the accuracy of data analysis is to be improved as the method for analyzing precipitation normalization in the prior art is difficult to adapt to precipitation distribution features under different climatic conditions, the present invention provides a method and system for analyzing precipitation normalization based on gradient parameter optimization.

In order to solve the above technical problem, the present invention adopts the technical solution as follows:
a method for analyzing precipitation normalization gradient-based parameter optimization, including the following steps:
S1: acquiring precipitation data to be analyzed;
S2: constructing a normal transformation model to perform normal transformation on the precipitation data, so as to obtain a normal variable Z, wherein the normal transformation model comprises corresponding normal transformation parameters;
S3: letting the normal variable Z to obey normal distribution and constructing a joint probability density function of the normal variable Z;
S4: constructing a likelihood function for parameter optimization based on the normal transformation model and the joint probability density function, wherein parameters to be optimized comprise normal distribution parameters and the normal transformation parameters;
S5: deducing an analytic gradient vector of the likelihood function to optimize the likelihood function till a predetermined termination condition is satisfied, so as to obtain an optimum parameter enabling a maximum value of the likelihood function; and
S6: updating the normal transformation model based on the optimum parameter, and performing normal transformation and modeling analysis on the precipitation data to obtain a precipitation normalization analysis result.

In the technical solution, the likelihood function is optimized by deducing the analytic gradient vector of the likelihood function, so that the parameter optimization process of normal transformation is simplified. Meanwhile, parameter estimation of different normal transformations is completed to obtain a precipitation normalization analysis result adaptive to precipitation distribution features under different climatic conditions.

Further, the present invention further provides a system for analyzing precipitation normalization gradient-based parameter optimization, applied to the method for analyzing precipitation normalization gradient-based parameter optimization. The system for analyzing precipitation normalization includes:
a data acquisition module, configured to acquire precipitation data to be analyzed;
a normal transformation module, configured to construct a predetermined normal transformation model to perform normal transformation on the precipitation data, so as to obtain a normal variable Z;
a normal distribution module, configured to let the normal variable Z to obey normal distribution to construct a joint probability density function of the normal variable Z;
an optimization module, configured to construct a likelihood function for parameter optimization based on the normal transformation model and the joint probability density function and deduce an analytical expression of gradient vector of the likelihood function to optimize the likelihood function till a predetermined termination condition is satisfied, so as to update the normal transformation model in the normal transformation module after the optimum parameter which enables the maximum value of the likelihood function is obtained; and
an analysis module, configured to perform modeling analysis according to the normal variable Z outputted by normal transformation module which is optimized and updated, so as to output a precipitation normalization analysis result.

Compared with the prior art, the technical solution of the present invention has the following beneficial effects: by deducing the analytical expression of gradient vector of the likelihood function and by adopting the maximum likelihood estimation method for optimization, the parameters can be adaptively optimized according to different distribution features of precipitation, so as to adapt to precipitation distribution features under different climatic conditions, thereby reducing the difficulty of conducting precipitation normalization work by hydrometeorological workers.

### BRIEF DESCRIPTION OF THE DRAWINGS

FIG. 1 is a flow diagram of a method for analyzing precipitation normalization gradient-based parameter optimization in the embodiment 1.

FIG. 2 is a histogram of a frequency distribution of standardized precipitation data before and after normal transformation in the embodiment 2.

FIG. 3 is a quantile diagram of normal distribution of the standardized precipitation before and after normal transformation in the embodiment 2.

FIG. 4 is a schematic diagram of skewness coefficients of original precipitation and precipitation after normal transformation in the embodiment 2.

FIG. 5 is a schematic diagram of coefficients of kurtosis of original precipitation and precipitation after normal transformation in the embodiment 2.

FIG. 6 is a schematic diagram of p-values of Shapiro-Wilk test of original precipitation and precipitation after normal transformation in the embodiment 2.

FIG. 7 is a schematic diagram of Filliben r statistic values of original precipitation and precipitation after normal transformation in the embodiment 2.

FIG. 8 is an architecture diagram of a system for analyzing precipitation normalization in the embodiment 3.

### DESCRIPTION OF THE EMBODIMENTS

The drawings are merely used for exemplary description and are not construed as limitation to the patent.

In order to better describe the embodiments, some parts in the drawings will be omitted, amplified or lessened and the drawings do not represent the dimensions of actual products.

For those skilled in the art, it can be understood that some known structures and description thereof in the drawings may be omitted.

The technical solution of the present invention will be further described below in combination with the drawings and the embodiments.

### Embodiment 1

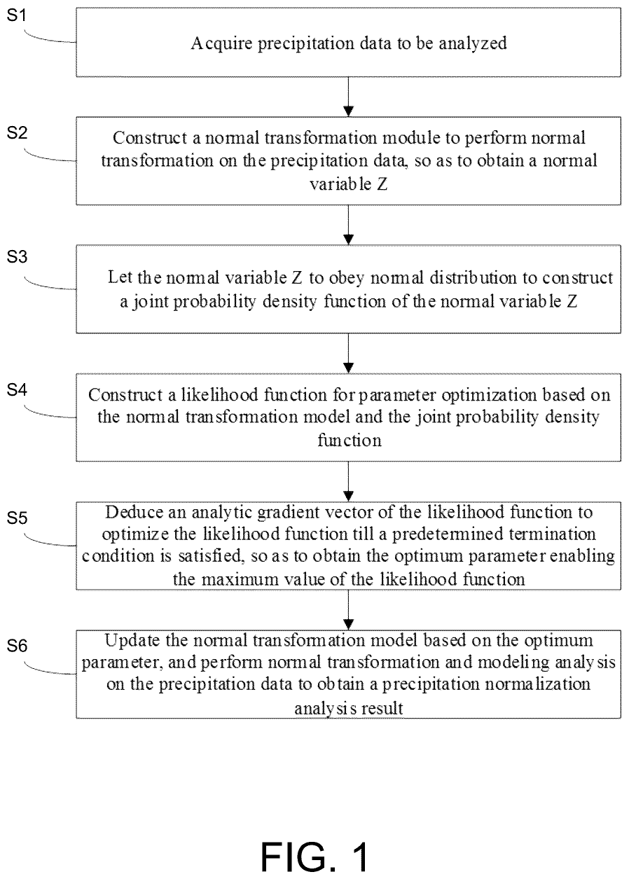

The embodiment provides a method for analyzing precipitation normalization gradient-based parameter optimization. FIG. 1 is the flow diagram of a method for analyzing precipitation normalization.

The method for analyzing precipitation normalization gradient-based parameter optimization provided by the embodiment includes the following steps:
S1: precipitation data to be analyzed is acquired;
S2: a normal transformation model is constructed to perform normal transformation on the precipitation data, so as to obtain a normal variable Z, wherein the normal transformation model comprises corresponding normal transformation parameters;
S3: let the normal variable Z obey normal distribution to construct a joint probability density function of the normal variable Z;
S4: a likelihood function for parameter optimization is constructed based on the normal transformation model and the joint probability density function.
wherein parameters to be optimized include normal distribution parameters and the normal transformation parameters;
S5: an analytic gradient vector of the likelihood function is deduced to optimize the likelihood function till a predetermined termination condition is satisfied, so as to obtain the optimum parameter enabling the maximum value of the likelihood function; and
S6: the normal transformation model is updated based on the optimum parameter, and normal transformation and modeling analysis are performed on the precipitation data to obtain a precipitation normalization analysis result.

In the embodiment, optimization is performed by constructing the likelihood function and deducing the analytic gradient vector of the likelihood function, and the parameters can be adaptively optimized according to different distribution features of precipitation to adapt to precipitation distribution features under different climatic conditions, thereby reducing the difficulty of conducting precipitation normalization work by hydrometeorological workers.

In an optional embodiment, the constructed normal transformation model is based on one or more of Log transformation, Box-Cox transformation or Log-sinh transformation.

X=[x₁,x₂, . . . xₙ] denotes for n samples of the precipitation data, and Z=[z₁,z₂, . . . , zₙ] represents corresponding normal variables after the normal transformation.

So, the expression of the normal transformation model based on Log transformation is as follows:

$${Z}_{Log} ( X ; c ) = log ( X + c ) ; \qquad ( 1 )$$

where log(·) represents a natural logarithm function, and c represents a parameter of Log transformation, is usually a nonnegative number and is used for processing a condition that Log transformation is meaningless when X=0.

A first-order derivative of Log transformation on X is:

$${Z}_{Log}^{′} ( X ; c ) = {( X + c )}^{- 1} ; \qquad ( 2 )$$

Thus it can be seen that there is only one parameter to be optimized in the normal transformation model based on Log transformation, which is the parameter c.

The expression of the normal transformation model based on Box-Cox transformation is as follows:

$${Z}_{Box - Cox} ( X ; {λ}_{1} , {λ}_{2} ) = \{ \begin{matrix}\frac{{( X + {λ}_{2} )}^{{λ}_{1}} - 1}{{λ}_{1}} , {λ}_{1} \neq 0 \\ log ( X + {λ}_{2} ) , {λ}_{1} = 0\end{matrix} ; \qquad ( 3 )$$

where Z_{Box-Cox}(·) represents a normal variable set subjected to Box-Cox transformation, and λ₁ and λ₂ are normal transformation parameters of Box-Cox transformation.

The value range of λ₁ is [−2, 2]. It can be known from the equation (3) that when λ₁=0, Box-Cox transformation is equal to Log transformation, and at this time, the effect of the parameter λ₂ is the same as the parameter c, and the parameter λ₂ is used for processing a condition that Box-Cox transformation is meaningless when X=0. λ₂ is usually a nonnegative number, and meanwhile, λ₂ can also be fixed to be 0 or other positive numbers.

A first-order derivative of Box-Cox transformation on X is:

$${Z}_{Box - Cox}^{′} ( X ; {λ}_{1} , {λ}_{2} ) = {( X + {λ}_{2} )}^{{λ}_{1} - 1} ; \qquad ( 4 )$$

Thus it can be seen that the parameters to be optimized in the normal transformation model based on Box-Cox transformation are the parameters λ₁ and λ₂.

The expression of the normal transformation model based on Log-sinh transformation is as follows:

$${Z}_{Log - sinh} ( X ; α , β ) = β log [ sinh ( \frac{α + X}{β} ) ] ; \qquad ( 5 )$$

where Z_{Log-sinh}(·) represents a normal variable set subjected to Log-sinh transformation, and α and β are normal transformation parameters of Log-sinh transformation. When the parameter β approaches to be infinitely great, the effect of Log-sinh transformation is similar to that of Log transformation.

A first-order derivative of Log-sinh transformation on X is:

$${Z}_{Log - sinh}^{′} ( X ; α , β ) = coth ( \frac{α + X}{β} ) ; \qquad ( 6 )$$

coth(·) represents a hyperbolic cotangent function. Thus it can be seen that the parameters to be optimized in the normal transformation model based on Log-sinh transformation are the parameters α and β.

In an optional embodiment. S3 includes the following steps:
S3.1: a numerical value less than or equal to a censored threshold x₀ in the precipitation data is regarded as a censored value; and
S3.2: it is assumed that the normal variable Z subjected to censored processing obeys normal distribution to construct the joint probability density function.

Further, the censored threshold x₀ is a real number equal to 0 or slightly greater than 0.

In the embodiment, in considering that the lower bound of precipitation is zero, the precipitation data shows discrete-continuous mixed distribution. In a conventional precipitation normalization process, the zero value of precipitation is usually processed by adding an offset coefficient without considering influence of mixed distribution of precipitation on parameter estimation. In the embodiment, the precipitation data is processed based on the censored threshold and is transformed to continuous distribution. Compared with a conventional processing mode, influence of mixed distribution of precipitation on parameter estimation can be entirely considered, so that the estimation result is more reasonable.

Further, it is assumed that the normal variable Z subjected to censored processing obeys normal distribution to construct the joint probability density function:

$$p ( Z \vert {μ}_{Z} , {σ}_{Z} ) = {\prod }_{i ∈ {Ω}_{1}} {p}_{N} ( {z}_{i} \vert {μ}_{Z} , {σ}_{Z} ) {\prod }_{i ∈ {Ω}_{0}} {ϕ}_{N} ( {z}_{i} ; {μ}_{Z} , {σ}_{Z} ) ; \qquad ( 7 )$$

where zᵢ∈Z represents the i^{th} precipitation data sample subjected to normal transformation in the normal variable Z; μ_{z} and σ_{z} represent a mean value and a standard deviation where the normal variable Z obeys normal distribution; p_{N}(·) represents a probability density function where the normal variable Z obeys normal distribution; ϕ_{N}(·) represents a cumulative distribution function of the normal variable Z; Ω₁ represents a set of sample indexes with the precipitation data greater than censored threshold x₀, wherein the number of samples in Ω₁ is marked as n₁; and Ω₀ represents a set of sample indexes with the precipitation data less than or equal to censored threshold x₀, wherein the number of samples in Ω₀ is marked as n₀, and n=n₀+n₁.

Based on the equation (7), the expression of the likelihood function for parameter optimization is as follows:

$$p ( X \vert θ ) = J \times {\prod }_{i ∈ {Ω}_{1}} {p}_{N} ( {z}_{i} \vert {μ}_{Z} , {σ}_{Z} ) \times {\prod }_{i ∈ {Ω}_{0}} {ϕ}_{N} ( {z}_{i} ; {μ}_{Z} , {σ}_{Z} ) ; \qquad ( 8 )$$

where θ represents a parameter set in the likelihood function p(X|θ), including the normal distribution parameters μ_{z} and σ_{z} and the normal transformation parameters; J represents a Jacobian matrix of normal transformation.

For the likelihood function p(X|θ) its logarithmic form is usually taken to obtain:

$$log p ( X \vert θ ) = log {\prod }_{i ∈ {Ω}_{1}} {Z}^{′} ( {x}_{i} ) - {n}_{1} log {σ}_{Z} - {( 2 {σ}_{Z}^{2} )}^{- 1} {\sum }_{i ∈ {Ω}_{1}} {( {z}_{i} - {μ}_{Z} )}^{2} - \frac{{n}_{1}}{2} log 2 π + {n}_{0} log [ 1 + erf ( \frac{{z}_{0} - {μ}_{Z}}{\sqrt{2} {σ}_{Z}} ) ] - {n}_{0} log 2 ; \qquad ( 9 )$$

where Z′(xᵢ) represents a first-order derivative of corresponding normal transformation, and are in the forms of equations (2), (4) and (6) respectively for Log. Box-Cox and Log-sinh transformations; and erf(·) represents an error function.

Further, in the embodiment, the likelihood function and its gradient information are optimized till a predetermined termination condition is satisfied, so as to obtain the optimum parameter enabling the maximum value of the likelihood function. Parameters to be optimized include normal distribution parameters μ_{z} and σ_{z} and the normal transformation parameters c. λ₁, λ₂, α and β.

In the embodiment, a maximum likelihood estimation method is used for optimization. i.e., to find a group of parameters, so that the maximum value of log p(X|0) in the equation (9) is acquired.

Further, in an optional embodiment, S5 includes the following specific steps:
S5.1: an initiating point θ⁰ of the parameter to be optimized is set; and
S5.2: iterative optimization is performed on the likelihood function based on the gradient vector by using the quasi-Newton method till the predetermined termination condition is satisfied, so as to obtain the optimum parameter enabling the maximum value of the likelihood function;
an iterative solution formula thereof is as follows:

$${θ}^{k + 1} = {θ}^{k} - {H}_{k}^{- 1} {g}_{k} ; \qquad ( 10 )$$

where θ^{k+1} and ok represent values of the parameter to be optimized in the (k+1)^{th} and k^{th} iterative processes; gₖ represents a value of the gradient vector formed by the parameter set θ in the likelihood function in the k^{th} iterative process; and represents an inverse matrix of a Hessian matrix in the k^{th} iteration.

In the embodiment, in considering that the calculating amount of the conventional global optimization algorithm is great, the time required by optimization is long, and the algorithm is affected by the local optimum value, the quasi-Newton method is used as the optimization algorithm. Meanwhile, based on the log-likelihood function log p(X|θ) in the equation (9), analytical solutions of gradients about different parameters are deduced as the gradient information, which aims to provide a direction for search by the algorithm and improve the search efficiency of the algorithm, thereby rapidly searching for the optimum parameter value. Common methods include the DFP algorithm (Davodpm-Fletcher-Powell), the BFGS algorithm (Broyden-Fletcher-Goldfard-Shano) and the like.

Further, the gradient of the log-likelihood function is formed by a first-order partial derivative of the log-likelihood function log p(X|θ) about the parameter. For Log, Box-Cox and Log-sinh transformation, the mean value μ_{z} and the standard deviation σ_{z} of the normalization variable Z need to be estimated.

The first-order partial derivative of the mean value μ_{z} is represented as:

$$\frac{\partial log p ( X \vert θ )}{\partial {μ}_{Z}} = - \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] + {σ}_{Z}^{- 2} {\sum }_{i ∈ {Ω}_{1}} ( {z}_{i} - {μ}_{Z} ) .$$

The first-order partial derivative of the standard deviation σ_{z} is represented as:

$$\frac{\partial log p ( X \vert θ )}{\partial {σ}_{Z}} = - \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] ( \frac{{z}_{0} - {μ}_{Z}}{\sqrt{2} {σ}_{Z}} ) - {n}_{1} {σ}_{Z}^{- 1} + {σ}_{Z}^{- 3} {\sum }_{i ∈ {Ω}_{1}} {( {z}_{i} - {μ}_{Z} )}^{2} .$$

Different normal transformation methods have different parameters. For the Log transformation, the first-order derivative of log p(X|θ) about the parameter c is:

$$\frac{\partial log p ( X \vert θ )}{\partial c} = \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] {( {x}_{0} + c )}^{- 1} + {\sum }_{i ∈ {Ω}_{1}} {( {x}_{0} + c )}^{- 1} - {σ}_{Z}^{- 2} {\sum }_{i ∈ {Ω}_{1}} \frac{{z}_{i} - {μ}_{Z}}{{x}_{i} + c} .$$

For the Box-Cox transformation, the first-order derivative of log p(X|θ) about the parameter λ₁ is:

$$\frac{\partial log p ( X \vert θ )}{\partial {λ}_{1}} = {\sum }_{i ∈ {Ω}_{1}} log ( {x}_{i} + {λ}_{2} ) - {σ}_{Z}^{- 2} {\sum }_{i ∈ {Ω}_{1}} \{ ( {z}_{i} - {μ}_{Z} ) \times \frac{( {λ}_{1} {z}_{i} + 1 ) [ {λ}_{1} log ( {x}_{i} + {λ}_{2} ) - 1 ] + 1}{{λ}_{1}^{2}} \} + \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] \cdot {λ}_{1}^{- 2} \{ ( {λ}_{1} {z}_{0} + 1 ) \times [ {λ}_{1} log ( {x}_{0} + {λ}_{2} ) - 1 ] + 1 \} .$$

When λ₁=0, the first-order derivative of log p(X|θ) about the parameter λ₁ is:

$$\frac{\partial log p ( X \vert θ )}{\partial {λ}_{1}} = {\sum }_{i ∈ {Ω}_{1}} log ( {x}_{i} + {λ}_{2} ) - {σ}_{Z}^{- 2} {\sum }_{i ∈ {Ω}_{1}} \{ ( {z}_{i} - {μ}_{Z} ) \times \frac{{log}^{2} ( {x}_{i} + {λ}_{2} )}{2} \} + \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] \times \frac{{log}^{2} ( {x}_{i} + {λ}_{2} )}{2} .$$

For the Box-Cox transformation, the first-order derivative of log p(X|θ) about the parameter λ₂ is:

$$\frac{\partial log p ( X \vert θ )}{\partial {λ}_{2}} = ( {λ}_{1} - 1 ) {\sum }_{i ∈ {Ω}_{1}} log ( {x}_{i} + {λ}_{2} ) - {σ}_{Z}^{- 2} {\sum }_{i ∈ {Ω}_{1}} [ ( {z}_{i} - {μ}_{Z} ) \times {( {x}_{i} + {λ}_{2} )}^{{λ}_{1} - 1} ] + \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] {( {x}_{0} + {λ}_{2} )}^{{λ}_{1} - 1} .$$

For the Log-sinh transformation, the first-order derivative of log p(X|θ) about the parameter α is:

$$\frac{\partial log p ( X \vert θ )}{\partial α} = - \frac{1}{β} \times {\sum }_{i ∈ {Ω}_{1}} \frac{1}{\frac{1}{2} sinh [ 2 ( \frac{α + {x}_{i}}{β} ) ]} - {σ}_{Z}^{- 2} {\sum }_{i ∈ {Ω}_{1}} ( {z}_{i} - {μ}_{Z} ) \times coth ( \frac{α + {x}_{i}}{β} ) + \sqrt{2} {{{n}_{0} ( \sqrt{π} {σ}_{Z} )}^{- 1} [ 1 + erf ( \frac{{z}_{0} - {μ}_{Z}}{\sqrt{2} {σ}_{Z}} ) ]}^{- 1} exp [ - {( \frac{{z}_{0} - {μ}_{Z}}{\sqrt{2} {σ}_{Z}} )}^{2} ] coth ( \frac{α + {x}_{0}}{β} ) .$$

For the Log-sinh transformation, the first-order derivative of log p(X|θ) about the parameter β is:

$$\frac{\partial log p ( X \vert θ )}{\partial β} = \frac{1}{{β}^{2}} \times {\sum }_{i ∈ {Ω}_{1}} \frac{α + {x}_{i}}{\frac{1}{2} sinh [ 2 ( \frac{α + {x}_{i}}{β} ) ]} - \frac{1}{{βσ}_{Z}^{- 2}} \times {\sum }_{i ∈ {Ω}_{1}} ( {z}_{i} - {μ}_{Z} ) \times [ {z}_{i} - coth ( \frac{α + {x}_{i}}{β} ) ( α + {x}_{i} ) ] + \sqrt{2} {{{n}_{0} ( β \sqrt{π} {σ}_{Z} )}^{- 1} [ 1 + erf ( \frac{{z}_{0} - {μ}_{Z}}{\sqrt{2} {σ}_{Z}} ) ]}^{- 1} \times exp [ - {( \frac{{z}_{0} - {μ}_{Z}}{\sqrt{2} {σ}_{Z}} )}^{2} ] [ {z}_{0} - coth ( \frac{α + {x}_{0}}{β} ) ( α + {x}_{0} ) ] .$$

Based on the first-order partial derivative of each parameter, the gradient vector of the log-likelihood function can be acquired, specifically as follows:

for the Log transformation, the gradient vector of the log-likelihood function is:

$${g}_{Log} = {[ \frac{\partial log p ( X \vert θ )}{\partial c} , \frac{\partial log p ( X \vert θ )}{\partial {μ}_{Z}} , \frac{\partial log p ( X \vert θ )}{\partial {σ}_{Z}} ]}^{T} ;$$

for the Box-Cox transformation, the gradient vector of the log-likelihood function is:

$${g}_{Box - Cox} = {[ \frac{\partial log p ( X \vert θ )}{\partial {λ}_{1}} , \frac{\partial log p ( X \vert θ )}{\partial {λ}_{2}} , \frac{\partial log p ( X \vert θ )}{\partial {μ}_{Z}} , \frac{\partial log p ( X \vert θ )}{\partial {σ}_{Z}} ]}^{T} ;$$

for the Log-sinh transformation, the gradient vector of the log-likelihood function is:

$${g}_{Box - Cox} = {[ \frac{\partial log p ( X \vert θ )}{\partial α} , \frac{\partial log p ( X \vert θ )}{\partial β} , \frac{\partial log p ( X \vert θ )}{\partial {μ}_{Z}} , \frac{\partial log p ( X \vert θ )}{\partial {σ}_{Z}} ]}^{T} .$$

Further, in an optional embodiment, in S5.1, the step of setting the initiating point θ⁰ of the parameter to be optimized includes:
an initial estimated value θ⁰ of the parameter θ is set, and it is assumed that the parameter θ⁰ obeys uniform distribution in its range:

θ⁰˜U(Bₗ,Bᵤ)
wherein Bₗ and Bᵤ respectively represent a lower bound and an upper bound of the parameter θ; and
a plurality of random points are randomly extracted from uniform distribution of the parameter θ⁰ as the initial point of the quasi-Newton method for solving.

In the embodiment, in considering that there may be a plurality of local optimum solutions for the likelihood function, a plurality of random points are randomly extracted from uniform distribution of the parameter θ⁰ as the initiating points of the quasi-Newton method for solving, and finally, a parameter combination which enables −log p(X|θ) to reach the minimum value (i.e., log p(X|θ) is enabled to reach the maximum value) is selected from the plurality of solved results as the finally acquired parameter optimization result θₒₚₜ;

$${θ}_{opt} = {argmin}_{θ} - log p ( X \vert θ )$$

where the parameter optimization result θₒₚₜ includes optimized values of the normal distribution parameters and the normal transformation parameters.

Further, in an optional embodiment, in S5.2, the terminating condition includes at least one of the following conditions:
(1) the value gₖ of the gradient vector in current iteration is less than a predetermined threshold ε_{g}; and
(2) The value change of the likelihood function in the two iterative processes is less than the predetermined threshold εₚ.

In the condition (1), when the value ∥gₖ∥ of the gradient vector is less than the threshold ε_{g}, it is considered that the likelihood function has been converged, so the current parameter set θ^{k} is the solved result, i.e., the optimum parameter.

In the condition (2), it is represented as ∥−log p(X|θ^{k+1})−┌−log p(X|θ^{k})┐|<εₚ, and at this time, it is considered that the likelihood function has been converged, so the current parameter set θ^{k} is the solved result, i.e., the optimum parameter.

The embodiment is applicable to parameter optimization for Log. Box-Cox and Log-sinh transformations, and its mathematical modeling process is achieved by the Python programming language, thereby facilitating achievement of automatic precipitation normal transformation. In the embodiment, by constructing the likelihood function and adopting the maximum likelihood estimation method for optimization, the analytical solutions of the gradients about different parameters are deduced to adapt to the precipitation distribution features in different climatic conditions, thereby effectively improving the accuracy of the precipitation data analytical result.

### Embodiment 2

The embodiment provides a specific implementation process by applying the method for analyzing precipitation normalization gradient-based parameter optimization provided by the embodiment 1.

In the embodiment, monthly precipitation of a global precipitation data product of Global Precipitation Climatology Centre is taken as input data, and the input precipitation data is subjected to data transformations including Log. Box-Cox and Log-sinh transformations. It includes the following specific steps:
S1: a Global Precipitation Climatology Centre dataset in NetCDF format is adopted, is read by an open_dataset function in a Python third-party library xarray to extract global precipitation observation data in July, so as to acquire the precipitation data to be analyzed, and the precipitation data to be analyzed is stored in a variable named as xr_gpcc_precip.
S2: the precipitation data acquired in S1 is subjected to mathematic modeling analysis.

The censored threshold value x₀=0.01 is set and stored in a variable named as threshold; numerical values less than or equal to x₀ in the precipitation data are all replaced with x₀, and their position indexes are recorded in a variable named as mask; and meanwhile, the number of samples greater than x₀ and the number of samples less than or equal to x₀ are respectively stored in variables named as n₁ and n₀.

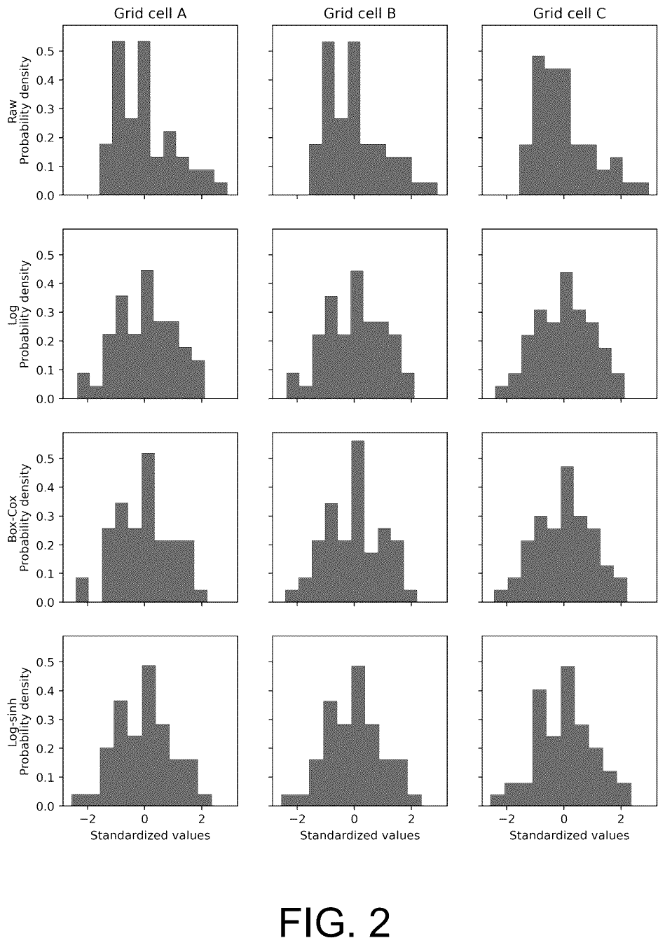

Then natural logarithm calculation is completed by the log function, hyperbolic sine calculation is completed by the sinh function, power calculation is completed by the power function, and error function calculation is completed by erf function in Numpy and Scipy, so that construction of the normal transformation and the likelihood function is completed.
S3: based on S2, the log-likelihood function is subjected to gradient analysis, and the mathematic process is encapsulated into the function.
S3.1: according to the form of the log-likelihood function in S2, the gradients thereof about different parameters are deduced, including the normal distribution parameters and the normal transformation parameters, wherein gradient calculation about parameters μ_{z}, σ_{z}, c, λ₁, λ₂, α and β are respectively defined as functions grad_mu, grad_sigma, grad_c, grad_l1, grad_l2, grad_alpha and grad_beta.
S3.2: joint probability density calculation. Log transformation Jacobian matrix calculation. Box-Cox transformation Jacobian matrix calculation and Log-sinh transformation Jacobian matrix calculation, in the likelihood function are respectively defined as functions norm, jac_log, jac_boxcox and jac_logsinh which are encapsulated into class Likelihood Functions in combination with functions in S3.1.
S3.3: the Log. Box-Cox and Log-sinh transformations are respectively defined functions log, boxcox and logsinh which are encapsulated into class PowerTrans.
S3.4: the above defined functions and classes are stored as files in .py format.
S4: the functions encapsulated in S3 are invoked by import sentence in Python for precipitation data normal transformation on the grids one by one in the Global Precipitation Climatology Centre.
S4.1: a plurality of initiating points, i.e., initial estimated values of each parameter, are set, and based on the log-likelihood function and its gradient in S2 and S3, parameter optimization is performed through the optimize.minimize function in Scipy by using the quasi-Newton method.
S4.2: the group of the log-likelihood function with the maximum value is selected from results acquired from different initiating points, and the corresponding parameter optimization result is used as the parameters for normal transformation of precipitation.
S4.3: different normal transformations (Log. Box-Cox and Log-sinh transformations) are applied to different grids in sequence to complete all normal transformations of precipitation.
S4.4: by taking the three grids as an example, a histogram of a frequency distribution of standardized precipitation data before and after normal transformation is plotted by the pyplot.hist function in Matplotlib, as shown in FIG. 2.

In FIG. 2, the original precipitation data represented in the first line integrally shows positively deviated characteristics, and the results in the second to the fourth lines shows a left-right symmetrical result, indicating that the present invention is capable of effectively estimating the normal transformation parameters, so as to better achieve normalization of the precipitation data.

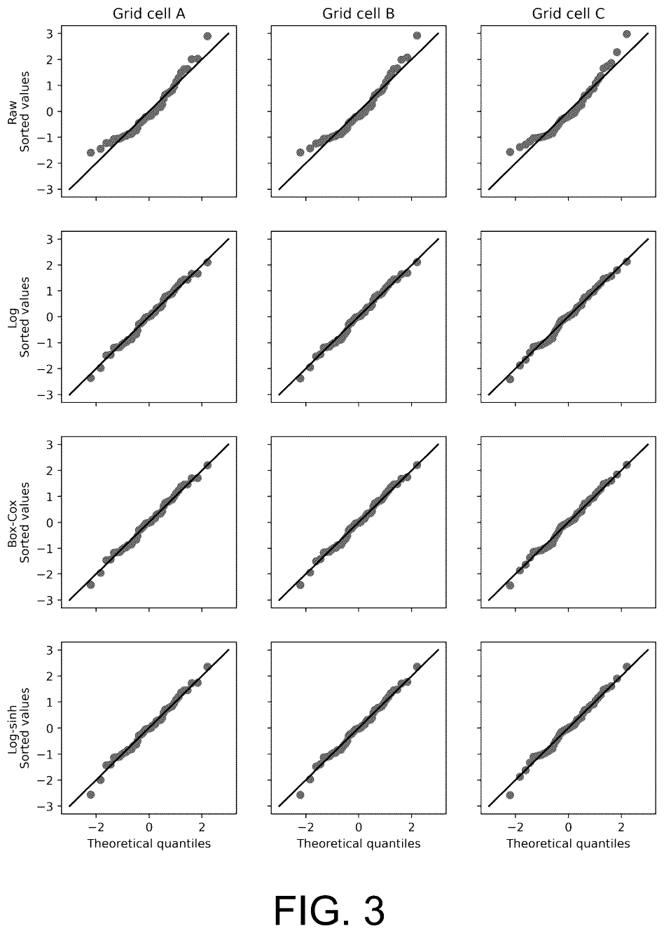

S4.5: a quantile diagram of normal distribution of the standardized precipitation before and after transformation, is plotted by the pyplot.scatter function, as shown in FIG. 3.

In FIG. 3, the first line represents the result of the original data of precipitation. It can be seen that the scatter diagram is deviated from 1:1 line, indicating that the original data is inconsistent with normal distribution. The second to the fourth lines represent results of different transformations and are integrally distributed along the 1:1 line, indicating that the normalization variable obtained based on the present invention obeys normal distribution.

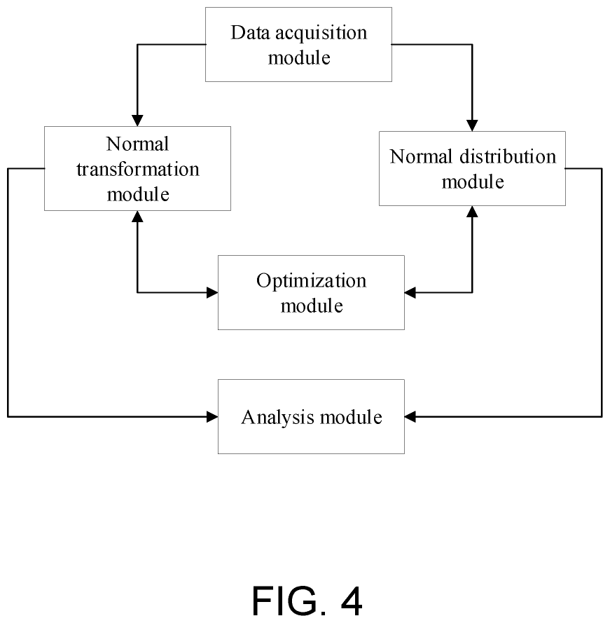

S4.6: normality test is performed on precipitation after normal transformation by using skew, kurtosis, shapiro and pearsonr functions in Scipy and Numpy, and the skewness coefficient, the kurtosis coefficient, the p-value of the Shapiro-Wilk test and the Filliben r statistic value obtained by calculation are plotted by Basemap, corresponding schematic diagrams shown in FIGS. 4-7.

FIG. 4 is the schematic diagram of skewness coefficients of original precipitation and precipitation after normal transformation, wherein the closer the skewness coefficient approaches to zero, the more consistent of the data is with normal distribution. FIG. 5 is the schematic diagram of kurtosis coefficients of original precipitation and precipitation after normal transformation, wherein the closer the kurtosis coefficient approaches to zero, the more consistent of the data is with normal distribution. FIG. 6 is the schematic diagram of p-values of Shapiro-Wilk test of original precipitation and precipitation after normal transformation, wherein the higher the p-value is, the more consistent of the data is with normal distribution. FIG. 7 is the schematic diagram of Filliben r statistic values of original precipitation and precipitation after normal transformation, wherein the higher the Filliben r statistic value is, the more consistent of the data is with normal distribution. It can be known from the figures that viewed from different normality test metrics, compared with the original precipitation data, the normality of precipitation after normal transformation is significantly improved as a whole, indicating that the present invention is capable of effectively estimating parameters of different normal transformations of Log. Box-Cox and Log-sinh, so as to adapt to the different climatic features in the world, so that the present invention features good application effect and stability.

### Embodiment 3

A system for analyzing precipitation normalization gradient-based parameter optimization provided by the embodiment is applied to the method for analyzing precipitation normalization gradient-based parameter optimization provided in the embodiment 1. FIG. 8 is an architecture diagram of a system for analyzing precipitation normalization in the embodiment.

The system for analyzing precipitation normalization gradient-based parameter optimization provided by the embodiment includes the following steps:
a data acquisition module, configured to acquire precipitation data to be analyzed;
a normal transformation module, configured to construct a normal transformation model to perform normal transformation on the precipitation data, so as to obtain a normal variable Z;
a normal distribution module, configured to let the normal variable Z to obey normal distribution to construct a joint probability density function of the normal variable Z;
an optimization module, configured to construct a likelihood function for parameter optimization based on the normal transformation model and the joint probability density function and deduce an analytical expression of gradient vector of the likelihood function to optimize the likelihood function till a predetermined termination condition is satisfied, so as to update the normal transformation model in the normal transformation module after the optimum parameter which enables the maximum value of the likelihood function is obtained; and an analysis module, configured to perform modeling analysis according to the normal
variable Z outputted by the optimized and updated normal transformation module, so as to output a precipitation normalization analysis result.

In the embodiment, by optimization the parameters of Log. Box-Cox and Log-sinh transformation through an optimization module, the analytical solutions of the gradients about different parameters are deduced to adapt to the precipitation distribution features in different climatic conditions, thereby effectively improving the accuracy of the precipitation data analytical result.

Further, in an optional embodiment, the normal transformation module includes at least one of a Log transformation unit, a Box-Cox transformation unit and a Log-sinh transformation unit.

Further, in an optional embodiment, the data acquisition module is further configured to regard the numerical value less than or equal to the censored threshold x₀ in the precipitation data as the censored value according to the predetermined censored threshold x₀, to transmit the censored value to the normal transformation module to obtain the corresponding normal variable Z. and to input the corresponding normal variable into the normal distribution module to enable the normal variable Z subjected to censored processing to obey normal distribution for further constructing the normal distribution probability density function.

Further, in an optional embodiment, the optimization module adopts the quasi-Newton method for iterative optimization on the likelihood function based on the gradient vector. A plurality of random points are randomly extracted from uniform distribution of the parameter θ⁰ as the initiating points of the quasi-Newton method for solving, and finally, a parameter combination which enables −log p(X|θ) to reach the minimum value (i.e., log p(X|θ) is enabled to reach the maximum value) is selected from the plurality of solved results as the finally acquired parameter optimization result θₒₚₜ.

Same or similar marks correspond to same or similar parts.

The terms describing position relationships in the drawings are merely used for exemplary description and are not construed as limitation to the patent.

Apparently, the embodiments of the present invention are merely examples made for describing the present invention clearly and are not to limit the embodiments of the present invention. For those of ordinary skill in the pertained field, modifications or variations in other forms may be made on the basis of the above description. There are no need and no way to exhaust all the implementation modes. Any modification, equivalent replacement, improvement, etc. made within the spirit and principle of the present invention shall be regarded as within the protection scope of the claims of the present invention.

1. A method for analyzing precipitation normalization by gradient-based parameter optimization, comprising following steps:
S1: acquiring precipitation data to be analyzed;
S2: constructing a normal transformation model to perform a normal transformation on the precipitation data, so as to obtain a normal variable Z, wherein the normal transformation model comprises corresponding normal transformation parameters;
S3: letting the normal variable Z to obey a normal distribution to construct a joint probability density function of the normal variable Z;
S4: constructing a likelihood function for a parameter optimization based on the normal transformation model and the joint probability density function, wherein parameters to be optimized comprise normal distribution parameters and the normal transformation parameters;
S5: deducing an analytic gradient vector of the likelihood function to optimize the likelihood function till a predetermined termination condition is satisfied, so as to obtain an optimum parameter enabling a maximum value of the likelihood function; and
S6: updating the normal transformation model based on the optimum parameter, and performing the normal transformation and a modeling analysis on the precipitation data to obtain a precipitation normalization analysis result.

2. The method for analyzing precipitation normalization according to claim 1, wherein in S2, the normal transformation model constructed is based on one or more of a Log transformation, a Box-Cox transformation or a Log-sinh transformation;
wherein an expression of the normal transformation model based on the Log transformation is as follows:
$${Z}_{Log} ( X ; c ) = log ( X + c ) ;$$
an expression of the normal transformation model based on the Box-Cox transformation is as follows:
$${Z}_{Box - Cox} ( X ; {λ}_{1} , {λ}_{2} ) = \{ \begin{matrix}\frac{{( X + {λ}_{2} )}^{{λ}_{1}} - 1}{{λ}_{1}} , {λ}_{1} \neq 0 \\ log ( X + {λ}_{2} ) , {λ}_{1} = 0\end{matrix} ;$$
an expression of the normal transformation model based on the Log-sinh transformation is as follows:
$${Z}_{Log - smh} ( X ; α , β ) = β log [ sinh ( \frac{α + X}{β} ) ] ;$$
wherein X represents a sample set of the precipitation data; Z_{Log}(·) represents a normal variable set subjected to the Log transformation, and c represents the normal transformation parameter of the Log transformation; Z_{Box-Cox}(·) represents a normal variable set subjected to the Box-Cox transformation, and λ₁ and λ₂ represent the normal transformation parameters of the Box-Cox transformation; and Z_{Log-sinh}(·) represents a normal variable set subjected to the Log-sinh transformation, and a and B represent the normal transformation parameters of the Log-sinh transformation.

3. The method for analyzing precipitation normalization according to claim 1, wherein in S3, the method further comprises following steps: regarding a numerical value less than or equal to a censored threshold x₀ in the precipitation data as a censored value; and then assuming that normal variable Z subjected to a censored processing obeys the normal distribution to construct the joint probability density function.

4. The method for analyzing precipitation normalization according to claim 3, wherein in S3, an expression of the joint probability density function constructed by the normal variable Z subjected to the censored processing is as follows:
$$p ( Z \vert {μ}_{Z} , {σ}_{Z} ) = {\prod }_{i ∈ {Ω}_{1}} {p}_{N} ( {z}_{i} \vert {μ}_{Z} , {σ}_{Z} ) {\prod }_{i ∈ {Ω}_{0}} {ϕ}_{N} ( {z}_{i} ; {μ}_{Z} , {σ}_{Z} )$$
wherein zᵢ∈Z represents an i^{th} precipitation data sample subjected to the normal transformation in the normal variable Z; μ_{z} and σ_{z} represent a mean value and a standard deviation where the normal variable Z obeys the normal distribution; p_{N}(·) represents a probability density function where the normal variable Z obeys the normal distribution; ϕ_{N}(·) represents a cumulative distribution function of the normal variable Z; Ω₁ represents a set of sample indexes with the precipitation data greater than the censored threshold x₀, wherein the number of samples in Ω₁ is marked as n₁; and Ω₀ represents a set of sample indexes with the precipitation data less than or equal to the censored threshold x₀, wherein the number of samples in Ω₀ is marked as no, and n=n₀+n₁.

5. The method for analyzing precipitation normalization according to claim 4, wherein in S4, an expression of the likelihood function for the parameter optimization constructed based on the normal transformation model and the joint probability density function is as follows:
$$p ( X \vert θ ) = J \times {\prod }_{i ∈ {Ω}_{1}} {p}_{N} ( {z}_{i} \vert {μ}_{Z} , {σ}_{Z} ) \times {\prod }_{i ∈ {Ω}_{0}} {ϕ}_{N} ( {z}_{i} ; {μ}_{Z} , {σ}_{Z} )$$
wherein θ represents a parameter set in the likelihood function p(X|θ), including the normal distribution parameters μ_{z} and σ_{z} and the normal transformation parameters; J represents a Jacobian matrix of the normal transformation;
the likelihood function is expressed in a form of logarithm as follows:
$$log p ( X \vert θ ) = log {\prod }_{i ∈ {Ω}_{1}} {Z}^{′} ( {x}_{i} ) - {n}_{1} log {σ}_{Z} - {( 2 {σ}_{Z}^{2} )}^{- 1} {\sum }_{i ∈ {Ω}_{1}} {( {z}_{i} - {μ}_{Z} )}^{2} - \frac{{n}_{1}}{2} log 2 π + {n}_{0} log [ 1 + erf ( \frac{{z}_{0} - {μ}_{Z}}{\sqrt{2} {σ}_{Z}} ) ] - {n}_{0} log 2$$
wherein the gradient vector is formed by a first-order partial derivative of a log-likelihood function log p(X|θ) about the parameter θ.

6. The method for analyzing precipitation normalization according to claim 5, wherein in S5, the method comprises following specific steps:
setting an initiating point θ⁰ of the parameters to be optimized; and
performing an iterative optimization on the likelihood function based on the gradient vector by using a quasi-Newton method till the predetermined termination condition is satisfied, so as to obtain the optimum parameter enabling the maximum value of the likelihood function; an iterative solution formula is as follows:
$${θ}^{k + 1} = {θ}^{k} - {H}_{k}^{- 1} {g}_{k}$$
wherein θ^{k+1} and θ^{k} represent values of the parameters to be optimized in (k+1)^{th} and k^{th} iterative processes; gₖ represents a value of the gradient vector formed by the parameter set θ in the likelihood function in a k^{th} iterative process, wherein the parameter set θ comprises the normal distribution parameters μ_{z} and σ_{z} and the normal transformation parameters; and Hₖ⁻¹ represents an inverse matrix of a Hessian matrix in the k^{th} iterative process.

7. The method according to claim 6, wherein the termination condition comprises at least one of following conditions:
(1) the value gₖ of the gradient vector in a current iterative process is less than a predetermined threshold ε_{g}; and
(2) the value change of the likelihood function in two iterative processes is less than, the predetermined threshold ε_{g}.

8. The method for analyzing precipitation normalization according to claim 6, wherein the step of setting the initiating point θ⁰ of the parameters to be optimized comprises:
setting an initial estimated value θ⁰ of the parameter θ, and assuming that the parameter θ⁰ obeys an uniform distribution in its range:
θ⁰˜U(Bₗ,Bᵤ)
wherein Bₗ and Bᵤ respectively represent a lower boundary and an upper boundary of the parameter θ; and
randomly extracting a plurality of random points from the uniform distribution of the parameter θ⁰ as an initial point of the quasi-Newton method for solving.

9. A system for analyzing precipitation normalization by gradient-based parameter optimization, applied to the method for analyzing precipitation normalization according to claim 1, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

10. The system for analyzing precipitation normalization according to claim 9, wherein the normal transformation module is comprised of at least one of a Log transformation unit, a Box-Cox transformation unit or a Log-sinh transformation unit.

11. A system for analyzing precipitation normalization by gradient-based parameter optimization, applied to the method for analyzing precipitation normalization according to claim 2, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

12. A system for analyzing precipitation normalization by gradient-based parameter optimization, applied to the method for analyzing precipitation normalization according to claim 3, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

13. A system for analyzing precipitation normalization by gradient-based parameter optimization, applied to the method for analyzing precipitation normalization according to claim 4, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

14. A system for analyzing precipitation normalization by gradient-based parameter optimization, applied to the method for analyzing precipitation normalization according to claim 5, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

15. A system for analyzing precipitation normalization by gradient-based parameter optimization, applied to the method for analyzing precipitation normalization according to claim 6, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

16. A system for analyzing precipitation normalization by gradient-based parameter optimization, applied to the method for analyzing precipitation normalization according to claim 7, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.

17. A system for analyzing precipitation normalization by gradient-based parameter optimization, applied to the method for analyzing precipitation normalization according to claim 8, comprising:
a data acquisition module, configured to acquire precipitation data to be analyzed;
a normal transformation module, configured to construct a predetermined normal transformation model to perform a normal transformation on the precipitation data, so as to obtain a normal variable Z;
a normal distribution module, configured to let the normal variable Z to obey a normal distribution to construct a joint probability density function of the normal variable Z;
an optimization module, configured to construct a likelihood function for a parameter optimization based on the normal transformation model and the joint probability density function, and deduce an analytical expression of gradient vector of the likelihood function to optimize the likelihood function till a predetermined termination condition is satisfied, so as to update the normal transformation model in the normal transformation module after an optimum parameter which enables a maximum value of the likelihood function is obtained; and
an analysis module, configured to perform a modeling analysis according to the normal variable Z outputted by the normal transformation module which is optimized and updated, so as to output a precipitation normalization analysis result.
